(19) United States
(12) Patent Application Publication
(10) Pub. No.: US 2024/0383605 A1
(43) Pub. Date: Nov. 21, 2024

(54) 9G CARGO NET

(71) Applicant: TULMAR SAFETY SYSTEMS INC., Hawkesbury (CA)

(72) Inventors: JONATHAN R. FRANCKI, Blainville (CA); BENOIT CORBEIL, Montebello (CA); VISHAL DHANANI, Hawkesbury (CA)

(21) Appl. No.: 18/667,379

(22) Filed: May 17, 2024

Related U.S. Application Data
(60) Provisional application No. 63/502,799, filed on May 17, 2023.

(51) Int. Cl. B64D 9/00

(52) U.S. Cl. CPC B64D 9/00

(57) ABSTRACT

A cargo barrier net is disclosed. The net includes polymer ropes being connected at nodes to form a net body, one or more ends of the ropes being attachable to a respective plurality of attachment points on an interior of an aircraft. The net further includes one or more node locks, each of the one or more node locks being installed on a respective node to reduce relative movement of the ropes at the node. The net accommodates a desired load factor of at least nine.

### CROSS-REFERENCE TO RELATED APPLICATIONS

This application claims priority to U.S. Provisional Patent Application Ser. No. 63/502,799, entitled “9G CARGO NET”, which was filed on May 17, 2023, the contents of which are incorporated herein by reference.

### FIELD

This application relates generally to netting for aircrafts and, in particular, to a 9G cargo net.

### BACKGROUND

Cargo barrier nets are used within aircraft to restrain cargo at a forward end of the cargo bay. In particular, during deceleration, cargo barrier nets are required to restrain and prevent the cargo from entering a forward area of the aircraft, including the cockpit. Various cargo barrier nets are known in the art. Prior art netting typically uses webbing. Nets using webbing are often too heavy for a single person to handle, requiring two or more people. Webbing may be damaged through friction, such as when the netting is dragged on a tarmac or other surface during handling. Webbing may become brittle in cold temperatures and absorbs water, becoming even heavier in wet conditions.

Accordingly, there is a desire for improved cargo barrier nets.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 shows a front view of a net according to embodiments of the present disclosure attached to a portion of an aircraft fuselage.

FIG. 2 shows a perspective view of the net of FIG. 1.

FIG. 3 shows a enlarged view of a portion of the net of FIG. 1.

FIG. 4 is a top view of the net of FIG. 1.

FIG. 5 is a side view of the net of FIG. 1.

FIG. 6 shows an embodiment of an attachment hook for the net of FIG. 1.

FIG. 7 shows a node of one embodiment of a net according to the present disclosure.

FIG. 8 shows a node lock according to embodiments of the present disclosure in an open configuration.

FIG. 9 shows the node lock of FIG. 8 in a closed configuration.

FIG. 10 shows a schematic front view of a net according to embodiments of the present disclosure.

FIG. 11 shows a left side view of the net of FIG. 10 with the remaining panels omitted for clarity.

FIG. 12 shows a right side view of the net of FIG. 10 with the remaining panels omitted for clarity.

FIG. 13 shows a top view of the net of FIG. 10 with the remaining panels omitted for clarity.

FIG. 14 shows a front view of the net of FIG. 10 with the remaining panels omitted for clarity.

FIG. 15 shows an enlarged view of a section taken from FIG. 14.

### DETAILED DESCRIPTION

9G cargo barrier nets derive their moniker from the requirement that they are able to withstand at least a max load factor of 9.00 of a desired load weight. Such cargo nets are made to retain the main portion of a main deck cargo hold. They provide protection between cargo and crew. Such barrier nets are generally installed at a forward end of the cargo bay, for example, by attachment to one or more attachment points on an interior of the fuselage of the aircraft. Depending on the aircraft, the attachment points may be arranged along a circular circumference of a frame member of the fuselage.

While use of ropes for netting is known, given the high loading requirements of a 9G net, rope has not been used as a basis for the net because the nodes of known nets using knots, stitching or even splicing have been insufficient under load. Knots, for example, compromise the transfer of load along the ropes, resulting in uneven distribution of load. Known splicing techniques may allow for load transfer along the rope, but also allow for relative movement particularly in very high load scenarios, such as in a 9G net.

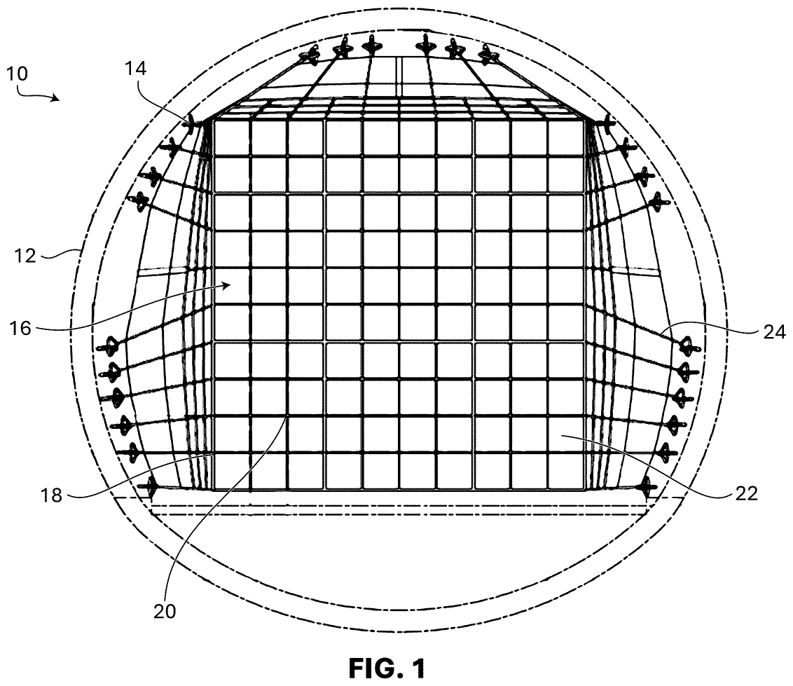

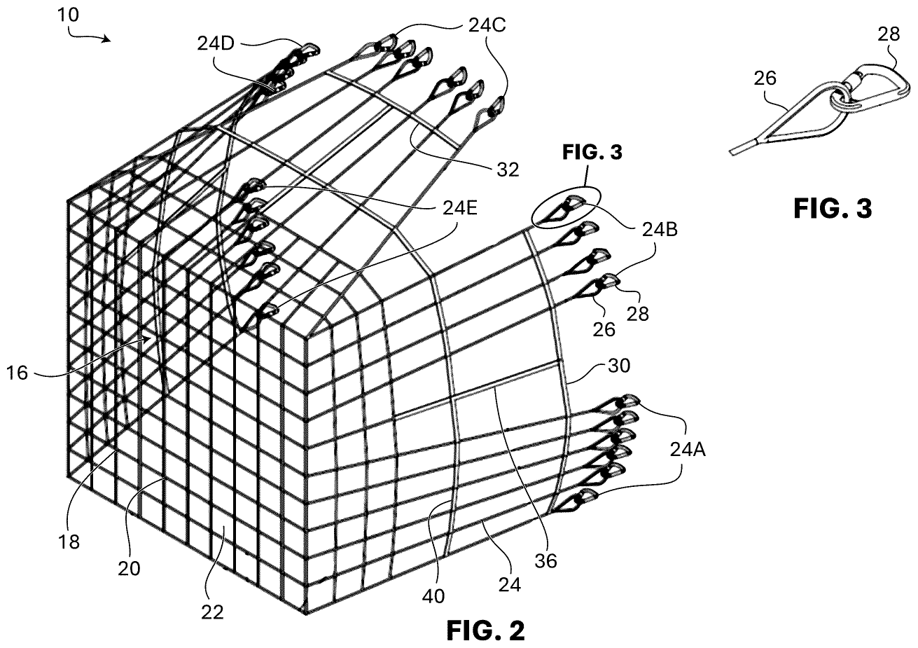

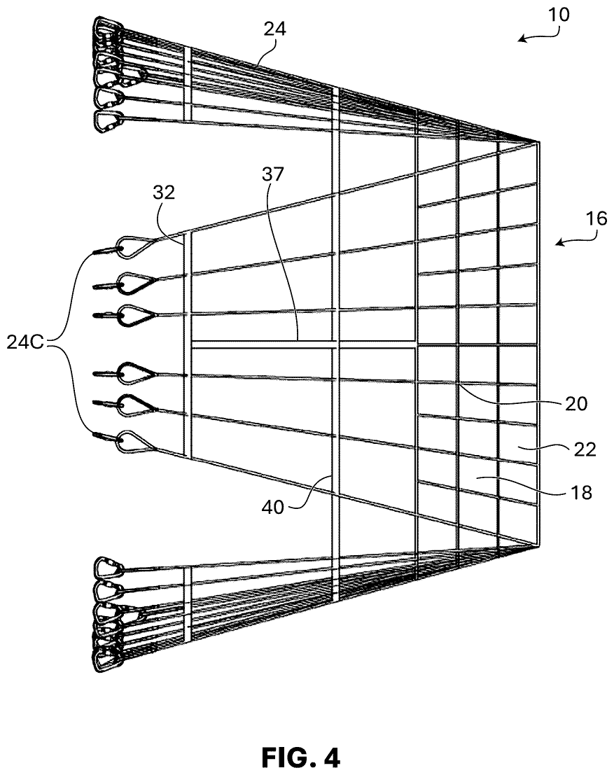

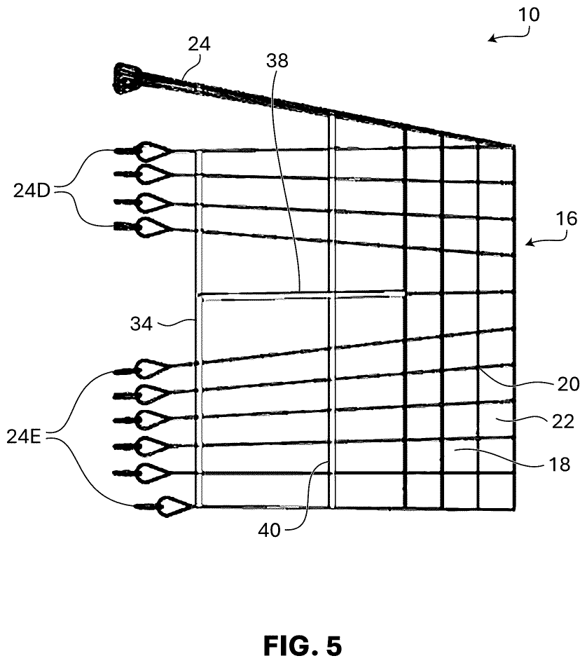

Referring to FIGS. 1 to 5, embodiments of a cargo barrier net according to the present disclosure will be described.

Cargo barrier net 10 is attached to part of a circular interior frame 12 of an aircraft fuselage at a plurality of attachment points 14. The net 10 includes a body 16 formed by a plurality of polymer ropes 18. The ropes 18 are connected to each other at nodes 20 of the net 10 without knotting or stitching. For example, the ropes 18 may be intertwined via full or partial splicing, as discussed in detail further below. The net body 16 has substantially square openings 22. In the illustrated embodiment, the squares have a nominal size of six-by-six inches. Other sizes and/or shaped of openings are possible, for example 6.25 inch squares.

Polymer tether lines 24 extend from the body 16 to attach the net at the plurality of the attachment points 14. In the embodiment shown, each tether line 24 has at its distal end an eye splice 26 to which a steel snap hook or carabiner 28 can be installed for attachment to the frame 12. Other embodiments are possible.

The tether lines 24 may be grouped into groups based on, for example, the relative location of the attachment points 12 to which the net 10 is to be attached. In the illustrated example, the tether lines are grouped into a first group 24A for attachment to right lower sidewall attachments, a second group 24B for attachment to right upper sidewall attachments, a third group 24C for attachment to ceiling attachments, a fourth group 24D for attachment to left upper sidewall attachments, and a fifth group 24E for attachment to left lower sidewall attachments.

Other embodiments are possible and depend on the configuration of attachments points to which the net will be attached. For example, the number of attachments points and corresponding tether lines may be increased or decreased. Similarly, the length, placement, and other parameters of the tether lines may be modified to accommodate different attachment configurations, such as those presented on different aircraft.

In the illustrated embodiment, the net 10 also includes a plurality of webbing. The webbing may act as an anti-tangle feature that aids in preventing the ropes of the net to tangle, making it easier to install and store. The webbing may also act as a barrier to prevent the bulk cargo (e.g. small boxes) from slipping out.

A webbing 30 is connected to and extends transversely to two or more of the tether lines 24 near the distal end thereof. Specifically, in the illustrated embodiment, the webbing 30 extends transversely across first and second groups 24A, 24B of the tether lines. Similarly, a webbing 32 extends across the third group 24C, and a webbing 34 extends across the fourth and fifth groups 24D, 24E.

In addition, a webbing 36 may extend from and connect to the net body 16. The webbing 36 extends to and connects with webbing 30. Similarly, a webbing 37 extends to and connects with the webbing 32 and a webbing 38 extends to and connects with the webbing 34. The webbing 36 and 38 extends generally transverse to the webbings 30 and 36, respectively. Moreover, in the illustrated embodiment, a webbing 40 extends across all of the tether lines 24 and is positioned between the net body 16 and the distal ends of the tether lines 24.

The webbing may be stitched to the ropes and tether lines or connected in another known manner.

Other embodiments are possible. In some embodiments there may be more or fewer webbing. The webbing may traverse the ropes at various angles and/or be connected to fewer or more ropes than shown in the illustrated embodiment.

The webbing acts primarily as a visual aid for installation and de-installation and to reduce entangling of the net. In some embodiments, including the illustrated embodiment, the webbing has a negligent effect on the strength and load bearing ability of the net.

In some embodiments, the net 10 is constructed with 0.5 inch diameter polymer rope. For example, the rope may be comprised of 12 strand, woven, ultra high molecular weight polyethylene (UHMWPE) sold under the brand Dyneema®. Using this material may allow for a light weight net that meets desired load requirements.

Accordingly, use of a rope net may allow for a light weight net capable of being installed by an individual rather than two or more people.

In some embodiments, the webbing elements near the left and right hand attachments points of the frame may be colour coded, e.g. red and green, respectively, to simplify installation of the net. Other colour coding, including colour coding of ropes may be possible.

The net may be configured such that each tether line is subject to substantially similar loading during expected operation, accounting for changes in load density across the net. This may be achieved via controlling the relative length and orientation of the tether lines. It will be understood that this configuration is dependant on the configuration of the attachment points and may vary without departing from the scope of the present disclosure. In some embodiments, a debris mesh may be included to prevent smaller debris from passing through the net.

In some embodiments, the nets according to the present disclosure may be configured as organizational nets that restrain cargo in its loaded zone rather than acting as a barrier net at the front of the aircraft cabin or cargo bay. Because the net is still capable of a max load factor of nine, in such embodiments, a separate barrier net at the front of the aircraft cabin or cargo bay may be omitted. Changes to the size, openings, tether lines and/or webbing may be required for use as an organizational net. For example, there may be visual aids and/or colour coding included to aid the use as an organizational net, For example, more or fewer tether lines may be required.

In some embodiments, organizational tethers may be included. The organizational tethers may be colour coded to aid in arrangement, storage, installation, etc. of the net.

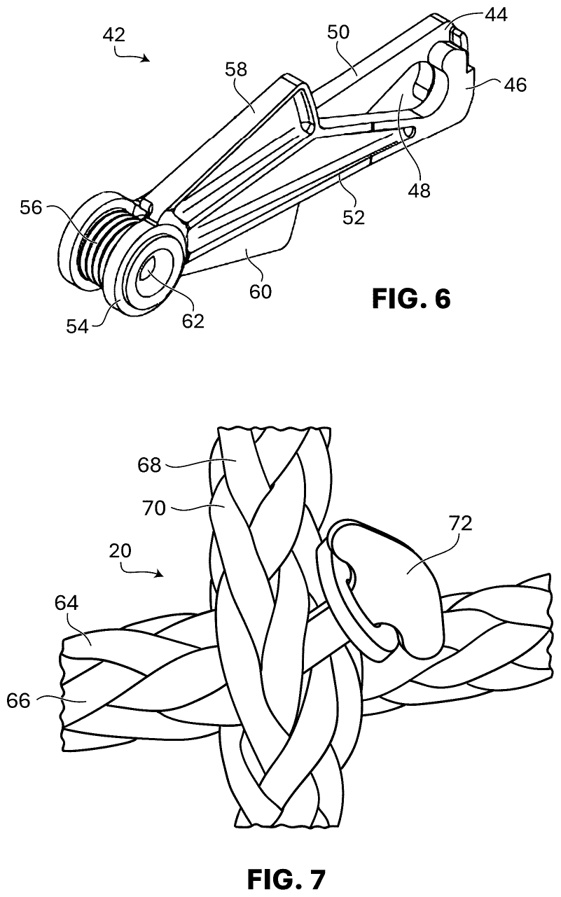

Embodiments of the net according to the present disclosure may be attached to the frame 12 with a variety of attachments means and methods that would satisfy the necessary loading and safety requirements. Referring to FIG. 6, one embodiment of a possible attachment hook will be described. The attachment hook 42 includes two opposing hook ends 44 and 46 that, in a neutral, closed position, overlap and form a closed hook loop 48 that is intended to surround and hook onto a portion of the frame 12. The hook ends 44, 46 are positioned on the ends of respective arms 50, 52 that partially or fully extend and pivot around a cylindrical thimble 54. The arms 50, 52 are connected by a torsion spring 56 that is positioned around the thimble 54 and biases the arms into the neutral, closed position. The arms 50, 52 include respective handles 58, 60 that, in the illustrated embodiment, are configured as outcroppings that extend from the arms 50, 52 and in opposing directions from each other. Pressing on the handles 58, 60 counteracts the spring force of the torsion spring 56, separating the hook ends 44, 46 and opening the hook loop 48 for attachment to the frame 12.

A through opening 62 in the thimble 54 receives a portion of the net 10. The attachment hook 42 and, in particular, the torsion spring 56 may be dimensioned and configured to maintain the appropriate closure force on the hook ends 44, 46 and keep the hook attached to the frame 12 in expected operating conditions.

As discussed above, the rope of net 10 and, specifically, the nodes 20 may be knotless and/or provided without stitching. In one embodiment, the nodes 20 are weaved together, as shown in FIG. 7. Namely, first rope 64 with strands 66, illustrated as horizontal, is fed through and in between strands 68 of second rope 70, illustrated as vertical.

Not all nodes 20 are necessarily weaved in the same manner. For example, in a first node a first rope may be fed between the strands of the second rope while in a second, adjacent node along the first rope, the weaving is reversed with a third rope being fed between the strands of the first rope. Similarly in another adjacent node along the second rope, the second rope may be fed between the strands of a fourth rope. This and other arrangements of weaving configurations at different nodes may aid in strengthening and/or distributing the forces over the net.

As shown in FIG. 7, a node lock 72 may be provided to help secure the weave connection between first and second ropes 64, 70. For example, the node lock 72 may aid in preventing the first and second ropes 64, 70 from shifting relative to each other when the net is put under tension. Specifically, in the illustrated node 20, the node lock 72 may prevent the first rope 64 from sliding between the strands 68 of the second rope 70.

The node lock 72 extends through and in between strands 66 and 68 of the first and second ropes, 64 and 70, respectively, and connects with itself to form a loop or brace around one or more strands of each of the ropes 64, 70.

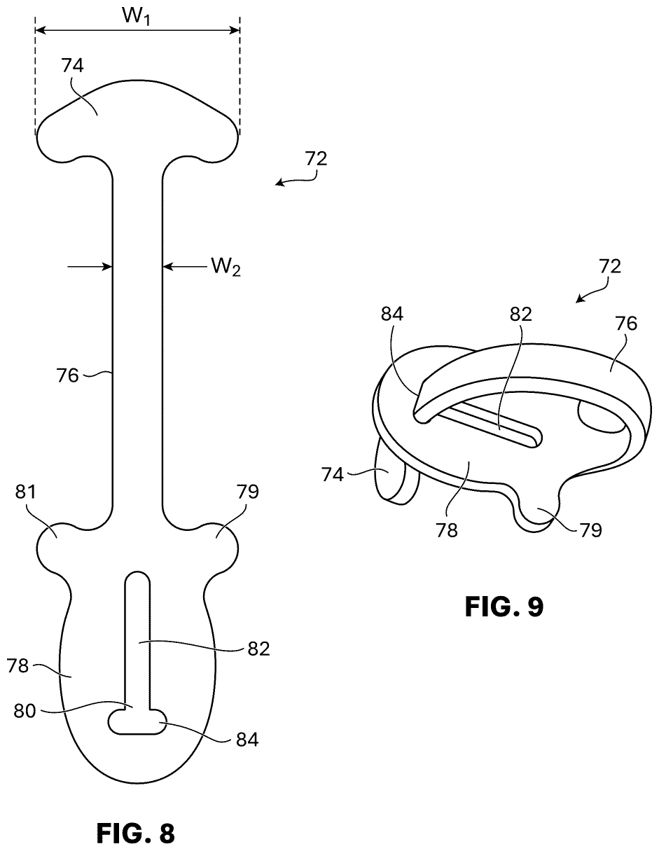

One embodiment of a node lock 72 according to the present disclosure is shown in FIGS. 8 and 9. The node lock 72 may be configured as a tie. The node lock 72 includes a curved and T-shaped hook portion 74, a bridge portion 76 and a loop portion 78, which the hook portion 74 may tie and hook into. The node lock further includes two ears, 79 and 81, extending from where the bridge portion 76 and the loop portion 78 meet. The loop portion 78 is configured with a T-shaped aperture 80 that has an elongate section 82 and a short section 84. The elongate section 82 is generally sized to accommodate and allow a width W₁ of the hook portion 74 to pass therethrough. The short section 84 is generally sized to accommodate and allow a width W₂ of the bridge portion 76, which is substantially narrower than the hook portion 74, to pass through.

Thus, once the hook portion 74 and bridge portion 76 are passed through the strands 66, 68, the hook portion 74 is fed through the elongate section 82 of the aperture 80 and turned so the bridge portion 76 occupies the short section 84. The hook portion 74 then hooks onto and presses up against the loop portion 78 to prevent the node lock 72 from coming undone.

Other embodiments for the node lock are possible and within the scope of the present disclosure. A node lock need not be flexible in nature or comprised of a single piece. The node lock may be formed of multiple pieces that are hinged or otherwise connected. In general, a node lock may comprise any construction or configuration that substantially permits the desired effect of reducing or preventing relative movement of the ropes at the node. The node lock need not close. For example a node lock may comprise an elongate portion that is fed through the node with ends configured to prevent the elongate portion from sliding out of the node. In some embodiments, node locks are not fed through the node but enclose an exterior of the node in a manner that prevents or reduces relative movement of the ropes at the node.

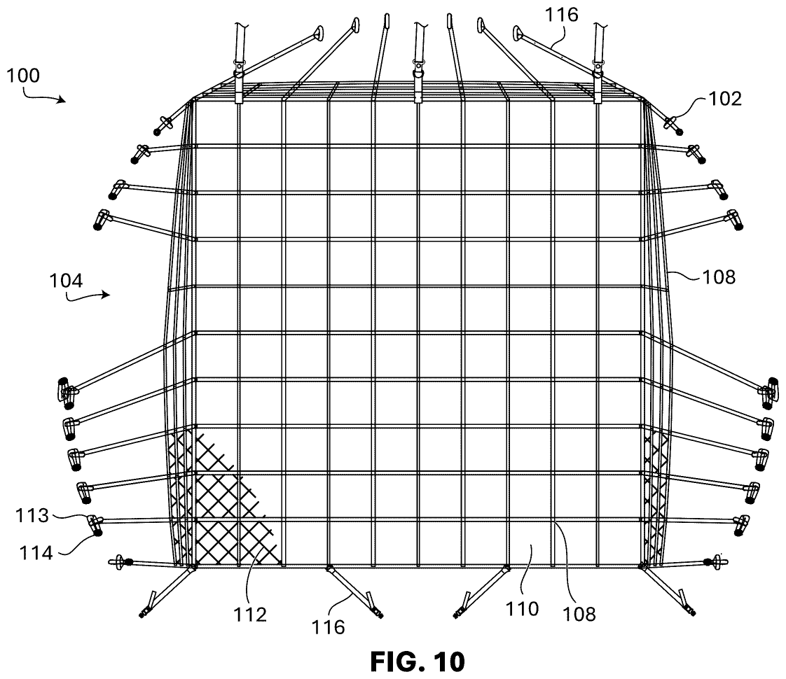

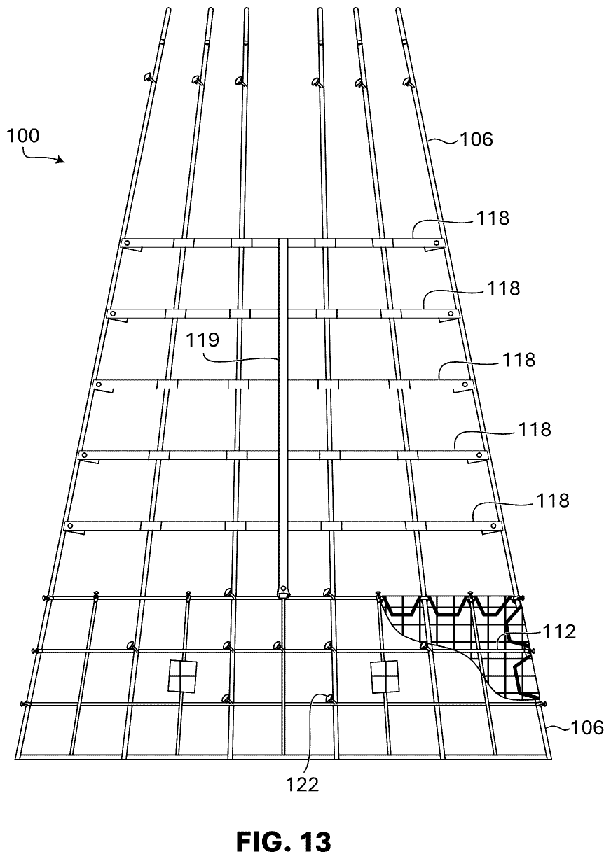

Referring to FIGS. 10 to 15, another embodiment of a cargo barrier net 100 according to the present disclosure is shown and described. Although different reference numerals will be used, features and description related to the embodiments of the net described above may apply equally to the net 100. It is noted that in FIGS. 10 to 15 not every element of the net 100 is shown in every figure for the sake of clarity. For example, node locks are omitted from FIG. 10.

The net 100 is attached to a frame (not shown) or portion of the aircraft fuselage at a plurality of attachment points 102. A net body 104 is formed by a plurality of polymer ropes 106. As discussed above, the ropes 106 may be formed of Dyneema®. The ropes 106 are connected to each other at nodes 108 of the net 100 without knotting or stitching. For example, the ropes 106 may be intertwined via full or partial splicing, as discussed herein. The net body 104 has substantially square openings 110. Other sizes and/or shaped of openings are possible.

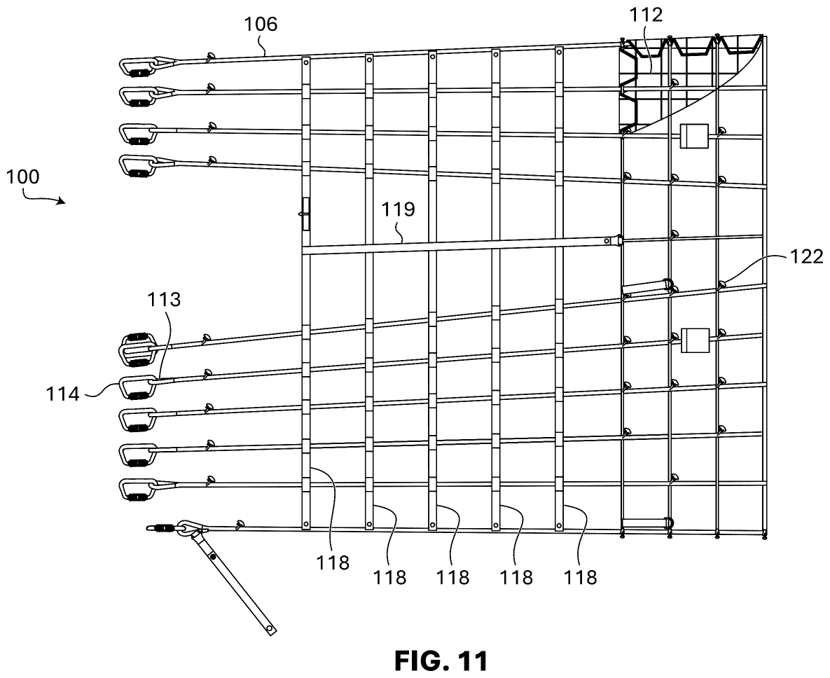

The net 100 may include a debris mesh 112, which, in FIG. 10, is shown as extending across a portion of the net 100 for clarity. The debris mesh 112 may extend across some or all of the net 100 or may be omitted entirely. In some embodiments, the debris mesh may be used to store the net 100. Namely, the debris mesh may be connected to, for example, the ceiling of the aircraft with straps, creating a hammock or pouch in which the net 100 is stored when not in use. It is noted that only portions of the debris mesh 112 are illustrated in FIGS. 11-15 for clarity. The debris mesh 112 will be understood to extend across the entire front panel and portions of the right, left and top panels of the net in the illustrated embodiment.

The ropes 106 each include at their terminal ends an eye splice 113 that may be used to attach the net 100 to the attachment points, for example using carabiners 114. The carabiners 114 may be used on some or all of the eye splice ends to attach the net 100. One or more straps 116, with or without cam buckle, may be included. The straps 116 may be fastened to the ropes 106 using snap assemblies by looping an end of the strap around a rope and using a snap button to close it. The straps 116 may be used for additional connection and/or storage of the net 100.

As shown in FIGS. 11 to 13, one or more webbing 118 may be included to run transverse to the ropes 106 on the right hand, left hand and/or top sides of the net 100. A webbing 119 may also be included to run transverse to the one or more webbing 118 and/or connect to the net body 104. In the illustrated embodiment, the net 100 incorporates five transverse webbing 118 spaced 8 inches apart and linked by across the webbing 119 that connects to side rope netting on each of the top, right hand side and left side hand panels of the net 100.

Node locks 122 may be provided at one or more nodes 108 of the net 100. The node locks 122 may be configured as described in respect of FIGS. 8 and 9. The node locks 122 are provided at nodes 108 where the ropes 106 may move relative to each other when subject to loading. The node locks 122 may impede relative movement of the ropes 106.

The node locks 122 are fed through a node 108, and closed on an exterior of the node for later release, if desired. Thus, in a closed state, the node lock 122 extends through a node 108. The node lock 122 may be made of durable, yet flexible materials such as rubber and/or silicone. In some embodiments, the strands of a rope 106 may be split equally into two groups with the node lock being fed between the two groups before closing for proper installation. For example, for a 12-strand rope, the rope may be split into two equal groups of six strands and the node lock may be fed, installed, etc. between the two groups of six strands.

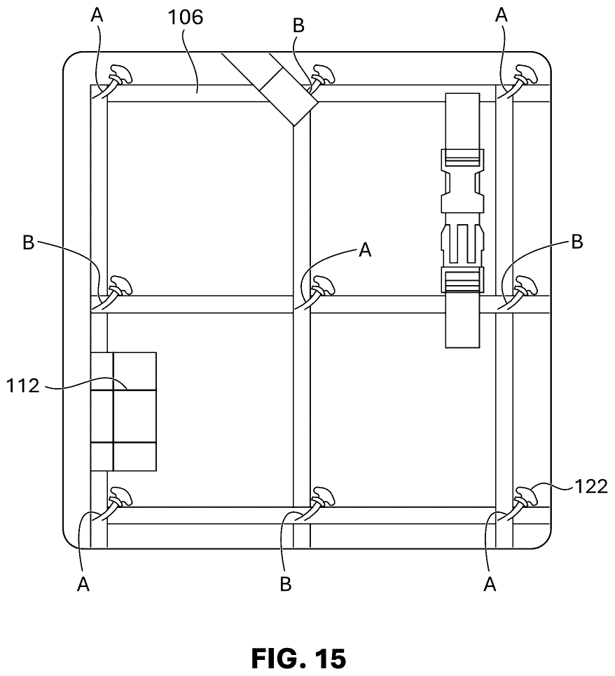

Moreover, to aid in reducing relative movement of the ropes 106, the splicing pattern may alternate at adjacent nodes. Referring to FIG. 15, at rope intersection or node type “A” a rope 106a, which runs horizontally, passes through a vertical rope 106b. At rope intersection or node type “B”. The vertical rope 106b pass through a horizontal rope 106c.

Node locks 122 may not be used in all nodes depending on the embodiment of the net. It may be desirable, in some embodiments, to reduce the number of node locks needed for proper operation of the net in order to simplify installation and/or reduce cost. For example, at a terminal end of a vertical rope, an eye splice may be provided with a buried tail which feeds back and is spliced into the rope. At an adjacent node along that rope, the horizontally running rope may be spliced into the vertical rope, as well as the buried tail, enabling a node that reduces the likelihood of relative movement of the ropes, reducing or eliminating the need for a node lock.

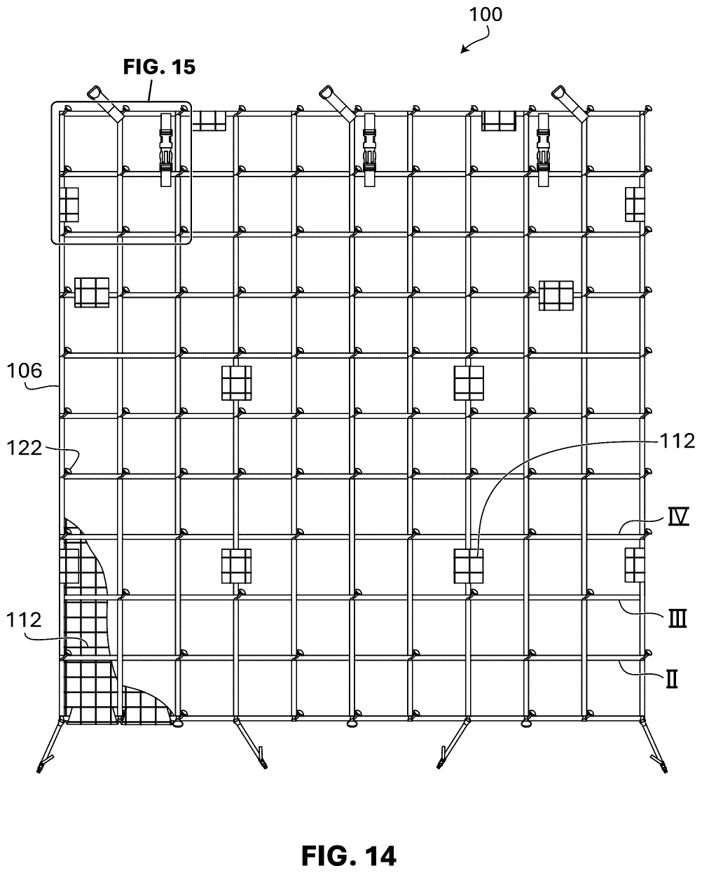

FIG. 14 illustrates an example distribution of node locks 122 on a front panel of the net. For example, in the second, third and fourth rows from the bottom, indicated by roman numerals II, III, and IV, respectively, a node lock is positioned at every second node from left to right, alternating between the rows.

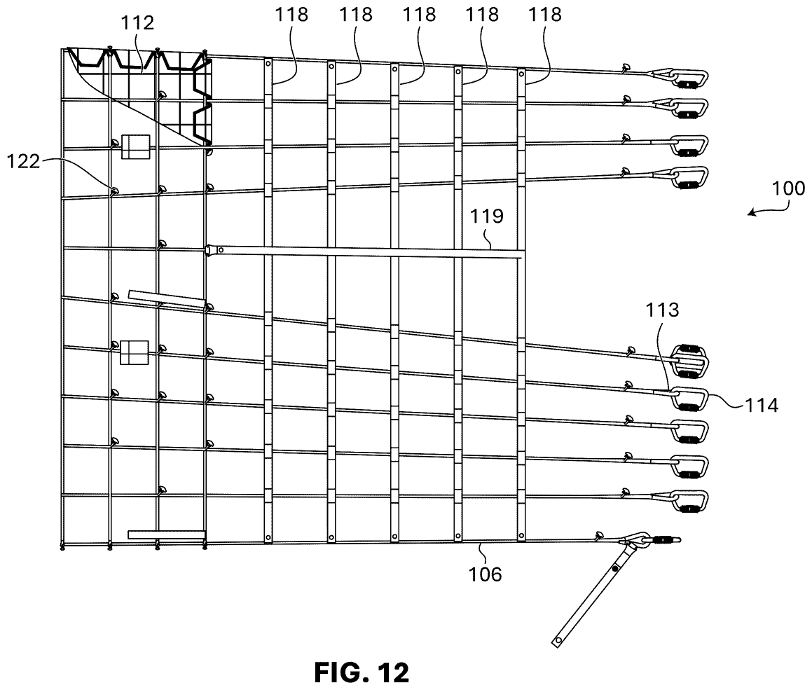

Similarly, FIGS. 11 and 12 illustrate example distributions of node locks 122 on the right hand side and left hand side panels.

In some embodiments, the net 100, once installed, may be able to resist operational loads of 18,234 lbs and 9G forward emergency loads of 288,117 lbs with a total maximum net distension of 22 inches.

Numerous specific details have been set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, terms such as “top”, “bottom”, “front”, “rear”, “downwards”, “upwards” and other directional terms are intended to aid in discussion of the relative features of embodiments of the disclosure, but are not limiting. It will be understood that these terms may be reversed or switched without altering the scope of the disclosure.

As used herein, the terms “comprises,” “comprising,” “includes,” “including,” “has,” “having” or any other variation thereof, are intended to cover a nonexclusive inclusion. For example, a composition, a process, method, article, or apparatus that comprises a list of elements is not necessarily limited to only those elements but may include other elements not expressly listed or inherently present therein.

As used herein the terms “approximately,” “about,” “substantially” and variations thereof are intended to include not only the exact value qualified by the term, but to also include some slight deviations therefrom, such as deviations caused by measuring error, manufacturing tolerances, wear and tear on components or structures, stress exerted on structures, and combinations thereof, for example.

Use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Moreover, it will be understood that features of one embodiment may be combined with features of other embodiments, even if not expressly recited or described as a combination.

1. A 9G cargo barrier net, comprising:
polymer ropes being connected at nodes to form a net body, one or more ends of the ropes being attachable to a respective plurality of attachment points on an interior of an aircraft; and
one or more node locks, each of the one or more node locks being installed on a respective node to reduce relative movement of the ropes at the node,
wherein the net is configured to have a desired emergency load factor of at least nine as compared to operational load.

2. The net of claim 1, wherein each of the one or more node locks is fed through the node and closed on an exterior of the node.

3. The net of claim 1, wherein the one or more node locks are configured as ties.

4. The net of claim 1, further comprising at least one webbing connected to and extending transversely across two or more of the ropes.

5. The net of claim 1, wherein the ends of the ropes are arranged in groups of two or more, each group having at least one respective webbing connected to and extending transversely across the ropes of the group.

6. The net of claim 4, further comprising a further webbing connected to and extending from the net body to one of the at least one webbing.

7. The net of claim 1, further comprising a debris mesh extending over at least a portion of the body.

8. The net of claim 7, wherein the debris mesh is used to store the net against a ceiling of the aircraft.

9. The net of claim 1, wherein the polymer ropes comprise 12-strand woven coreless rope.

10. The net of claim 1, wherein at each node having one of the one or more node locks, the strands of each rope at the node are split into two equal groups and the node lock is installed by feeding the node lock between the two groups.

11. The net of claim 1, further comprising organizational webbing.

12. The net of claim 1, wherein the net body is configured to have square openings.

13. The net of claim 1, wherein at a first node a first rope is passed through a center of a second rope and wherein at a second node, immediately adjacent to the first node, a third rope is passed through a center of the first rope.
